(19) United States
(12) Patent Application Publication
(10) Pub. No.: US 2015/0219278 A1
(43) Pub. Date: Aug. 6, 2015

(54) INTEGRATED DISPENSING STATION

(71) Applicant: LINDE AKTIENGESELLSCHAFT, Munich (DE)

(72) Inventors: Stephen Foster, Birchgrove (AU); Ron C. Lee, Bloomsbury, NJ (US); Kevin Peakman, Caringbah (AU)

(21) Appl. No.: 14/428,650

(22) PCT Filed: Sep. 10, 2013
(86) PCT No.: PCT/US13/58854

§ 371 Date: Mar. 17, 2015

Related U.S. Application Data
(60) Provisional application No. 61/702,875, filed on Sep. 19, 2012.

(51) Int. Cl. F17C 5/02; F17C 7/02

(52) U.S. Cl. CPC F17C 5/02; F17C 7/02; F17C 2221/033; F17C 2223/046; F17C 2223/033; F17C 2223/0161; F17C 2225/033; F17C 2225/0161; F17C 2227/0135; F17C 2227/0337; F17C 2250/0443; F17C 2265/065; F17C 2270/0139

(57) ABSTRACT

An LNG fueling station that is more compact in size and reduces the pipeline requirements between storage vessel and dispensing unit is described. The design allows for significantly reduced vehicle fueling times because all cryogenic components external to the LNG bulk storage tank are contained in a single location with little or no separation between the components. This ensures a minimum heat load to the cryogenic components external to the LNG bulk storage tank. The piping components of the fueling station are routed to provide passive cooling of critical components. The LNG fueling station can be operated with or without a pump and provides the advantages of modular component options.

### FIELD OF THE INVENTION

The present invention relates to dispensing stations for cryogenic fluids.

### BACKGROUND OF THE INVENTION

Dispensing of cryogenic fluids is important for many industries. One of the most important cryogenic fluids is Liquefied Natural Gas (LNG). LNG continues to increase in importance as a power source. Because of the physical state of natural gas, e.g. taking up a large volume, the direct use of natural gas is restricted to localized area production. This is because natural gas needs to be delivered by pipeline, therefore restricting the number of end users that are easily served. LNG overcomes some of the problems associated with the delivery of natural gas. In particular, LNG, which is natural gas that has been liquefied and compressed, takes up significantly less space that natural gas in the gaseous state, e.g. LNG is about 1/600^{th} the volume of the same amount of natural gas. Therefore, LNG makes it possible to transport natural gas by tanker or truck to almost any location where it can then be re-gasified for use by the customer.

LNG has changed the natural gas market making natural gas that was previously economically unrecoverable, now available. This includes gas reserves for which pipeline construction was too expensive. An LNG plant can now be constructed at the site and the LNG can be economically transported to the end user.

There are many methods of converting natural gas to LNG, primarily depending on the initial state of the natural gas, i.e. whether it is non-associated, no oil contact; overlies an oil reserve; or associated, dissolved in the oil. Different separation and purification methods are required to get natural gas, which is primarily methane, to the state that it can be liquefied. The natural gas is liquefied by lowering the temperature to about −260° F. (−160° C.) which liquefies the methane and allows for transportation at low pressure, in insulated tankers. The temperature of the LNG is maintained by auto-refrigeration, keeping the LNG at its boiling point so that any additions of heat are offset by energy loss from the LNG vapor which increases the pressure inside the storage vessel.

When the LNG reaches its destination, the LNG is offloaded from the tanker and is stored as a cryogenic fluid until needed.

One such method of distribution is through an LNG fueling station, for example a LNG fueling station for dispensing LNG to vehicle tanks. A typical LNG fueling station arrangement is shown in prior art FIG. 1, showing a storage vessel 10, for storing LNG delivered from a tanker or other transportation means; a pump 30, to draw LNG from the storage vessel 10 and deliver the LNG to a dispensing unit 40. A control system 50 is located remotely from the dispensing unit 40 to control the fueling operation. The LNG fueling station is designed to deliver LNG to a vehicle tank at a pressure between 75 PSI and 120 PSI, such pressure needed for proper operation of a natural gas engine.

The storage vessel 10 is a standard storage tank for LNG. Such tanks are designed to store the LNG at the low temperature, i.e. −260° F., needed to maintain the LNG in liquid state. LNG storage tanks generally have double containers, the inner container for holding the LNG and the outer container for housing insulation materials around the inner container. A common storage container is about 20 m (66 ft) tall with a 4 m (13 ft) diameter, The temperature of the LNG in the storage tank is maintained by auto-refrigeration, wherein LNG vapor is allowed to increase the pressure within the tank to maintain the LNG temperature.

The pump 30 is normally a cryogenic pump which draws the LNG from the storage vessel 10, for delivery to a LNG vehicle engine via the dispensing unit 40. The pump is also used to pressurize the LNG to the level necessary for the LNG vehicle engine.

There are several disadvantages associated with the current design of LNG fueling stations. In particular an LNG fueling station takes up a lot of space, e.g. an acre or more and constructions costs can be from $1,000,000 to over $2,000,000. In addition, a significant amount of piping is necessitated to deliver the LNG from the storage vessel to the dispensing unit. To reduce venting losses from this piping, the pipeline must be insulated or cooled, adding cost to the construction and operation of the LNG fueling station. The current LNG fueling stations are complex and require complicated control systems that lead to fairly long vehicle fueling times. Fueling times are increased because of the need to cool down the components prior to the start of fuel dispensing, particularly if there has been down time between fueling operations. LNG fueling is an intrinsically periodic process, even if there is not an extended down time between fueling operations. Therefore, it is difficult to keep the amount of heat load to the external pipework and components sufficiently low to prevent a disproportionate amount of vaporization and subsequent venting of the natural gas.

Therefore, there is a need in the art for improvements to LNG fueling stations

### SUMMARY OF THE INVENTION

The invention provides an LNG fueling station that is more compact in size and reduces the pipeline requirements between storage vessel and dispensing unit. In addition, the invention provides an LNG fueling station that significantly reduces vehicle fueling times. This is accomplished first through a design that ensures all cryogenic components external to the LNG bulk storage tank are contained in a single location with little or no separation between the components. This ensures a minimum heat load to the cryogenic components external to the LNG bulk storage tank. Further, according to the invention, all piping components of the fueling station are routed so that passive cooling of critical components is accomplished through gravity flow of LNG through the piping prior to fuel dispensing. Another feature of the invention is the physical arrangement of the components so that operation is enabled with or without a pump and provides the ability to use modular component options, while retaining the advantages of the features noted above.

With the arrangement and features of the invention, it is possible to either maintain critical components of the fueling station in a cold standby operation indefinitely (without compromising with excessive heat load to the system), or to quickly cool down the critical components prior to fueling. In particular, it is an important aspect of the invention that the pump is maintained in cold standby without excessive heat load, while the flow meter may be quickly cooled before fueling by either passive gravity flow or by active pumped LNG circulation.

The fueling station according to the invention is designed mechanically to utilize, where appropriate, natural phenomenon such as gravity and differential temperature liquid condensation in order to reduce energy input to the system and to increase efficiency of the dispensing operation. The line lengths are minimized to allow use of pumps, where fitted, to their full potential which provides the added benefit of facilitating the operation of the station when installed as a decant system.

The fueling station of the invention also incorporates the necessary control equipment into the dispenser. This is different than the prior art wherein a separate control unit is located at a remote location from the dispenser. By having the control associated directly with the dispenser, the cost of the station is reduced, the time needed for installation is reduces and quality control of the units exiting the factory is improved because testing is possible prior to shipment. In addition, the control system for the invention allows complete remote viewing and control from anywhere in the world where internet connection can be made. This facilitates operational support and customer service.

### BRIEF DESCRIPTION OF THE DRAWINGS

FIG. 1 is schematic diagram of an LNG fueling station as know in the prior art.

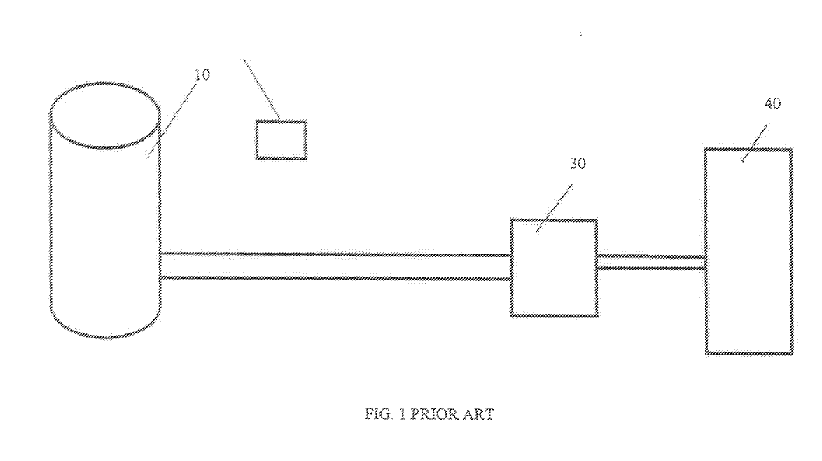

FIG. 2 is schematic diagram of an LNG fueling station according to an embodiment of the invention.

FIG. 3 is schematic diagram of an LNG fueling station according to another embodiment of the invention.

### DETAILED DESCRIPTION OF THE INVENTION

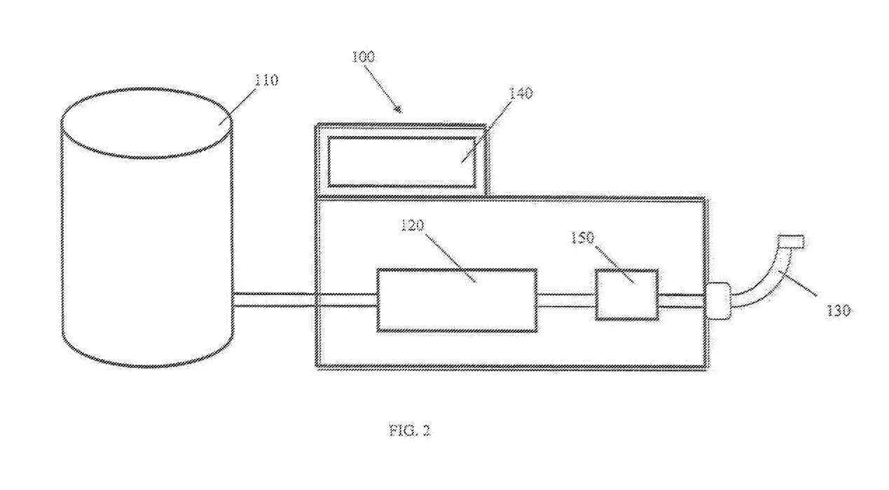

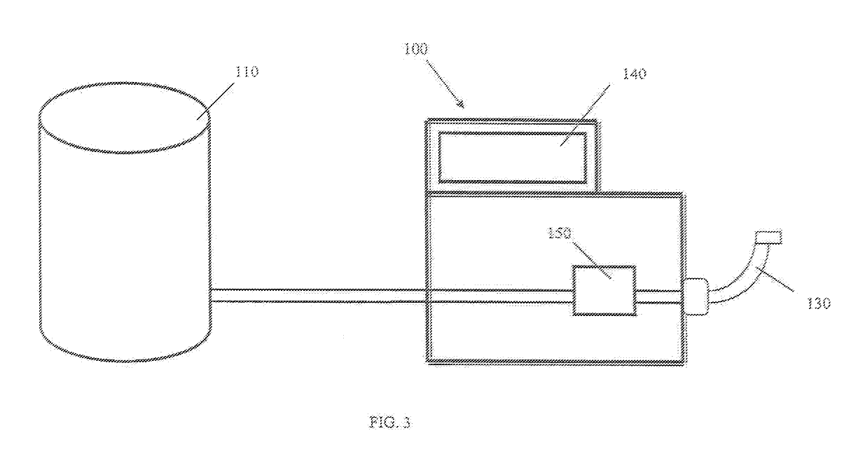

The present invention sill be described by reference to drawing FIGS. 2 and 3. FIG. 2 is schematic diagram of an LNG fueling station according to the invention, wherein a housing assembly 100 contains the components of the fueling station, the housing 100 communicating with a storage vessel 110. The housing 100, contains a pump 120, control system 140 and optionally a certified flow meter 150. A dispensing hose 130 communicates with the storage vessel 110 via the pump 120 and is used to dispense LNG fuel to a vehicle LNG engine tank. Incorporating the control system 140 into the housing 100 for the pump 120 and dispenser 130 provides the advantages noted above.

Further advantages of the invention include a much smaller space requirement for the LNG fueling station. Because of this smaller design, the pipeline requirement between components is significantly reduced. This lowers the capital cost and makes construction much faster, less expensive and allows for testing at the production site. The station according to the invention may have a modular design and allows for a modular installation process rather than a bespoke installation to each site. This means the units can be considered stock items and be pre-positioned to allow faster reaction to customer needs. The modular design of the LNG fueling station according to the invention allows growth of the fueling unit as customer need increases. Further, LNG liquid conversion to gas from heat in leak is nearly eliminated in the station of the invention. In addition fueling time is shortened because of the reduction of pipeline and the ability to start the fueling process more rapidly without initial cool down of components.

FIG. 3 is schematic diagram of an LNG fueling station according to another embodiment of the invention The design of the LNG fueling station in FIG. 3 is similar that of FIG. 2 with like components numbers with like reference numerals. In particular, the LNG fueling station of FIG. 3 includes the storage vessel 110. A dispensing hose 130 communicates with the storage vessel 110 and is used to dispense LNG fuel through a certified meter 150 to a vehicle LNG engine tank. In this design no pump is used but the control system 140 is still incorporated into the dispensing unit. The pump can be eliminated as the pressure within the storage vessel is sufficient to deliver the LNG through the dispensing hose 130. In this design, the pipeline connections are arranged to provide a downward slope from the storage vessel 110 to the dispensing hose 130 to aid flow of the LNG. The advantages of the design shown in FIG. 3 include all of those mentioned above with respect to the design shown in FIG. 2, and further simplify and reduce costs by eliminating the pump.

A further advantage of the invention is that the modularity allows the design to be essentially the same whether a pump is included or not. Therefore, construction consistency can be improved and interchangeability of design is accomplished.

While the above has been described with reference to LNG fueling stations, the invention is applicable to other cryogenic dispensing systems, such as the dispensing of liquid nitrogen and liquid hydrogen.

It will be understood that the embodiments described herein are merely exemplary and that one skilled in the art may make variations and modifications without departing from the spirit and scope of the present invention. All such variations and modifications are intended to be included within the scope of the invention as described above. Further, all embodiments disclosed are not necessarily in the alternative, as various embodiments of the invention may be combined to provide the desired result.

What is claimed is:

1. An LNG fueling station comprising:
a storage vessel for storing LNG;
a dispensing hose communicating with the storage vessel through a pump; and
a control system;
wherein the pump and control system are contained within a housing.

2. The LNG fueling station of claim 1, further comprising a flow meter located between the pump and the dispensing hose, the flow meter also contained by the housing.

3. An LNG fueling station comprising:
a storage vessel for storing LNG;
a dispensing hose communicating with the storage vessel through a flow meter; and
a control system;
wherein the flow meter and control system are contained within a housing.

4. The LNG fueling station of claim 1, wherein the arrangement of pipelines connecting the storage vessel to dispensing hose are of a generally downward sloping configuration to aid flow of LNG from the storage vessel to the dispensing hose.

5. The LNG fueling station of claim 1, wherein the pressure within the storage vessel is sufficient to deliver LNG through the dispensing hose.
